(19) United States
(12) Patent Application Publication
(10) Pub. No.: US 2019/0026529 A1
(43) Pub. Date: Jan. 24, 2019

(54) SURFACE TREATMENT METHOD

(71) Applicant: Primax Electronics Ltd., Taipei (TW)

(72) Inventor: Chih-Hao Hsu, Taipei (TW)

(21) Appl. No.: 15/811,606

(22) Filed: Nov. 13, 2017

(30) Foreign Application Priority Data
Jul. 21, 2017 (TW) 106124614

(51) Int. Cl. G06K 9/00; C09D 9/00

(52) U.S. Cl. CPC G06K 9/00033; C09D 9/00; G06K 9/00053

(57) ABSTRACT

The present invention provides a surface treatment method, applicable to surface treatment of a fingerprint sensing module and including the following steps: (a) providing a fingerprint sensing module; (b) radiating an ultraviolet curable resin layer of the fingerprint sensing module by using a laser; (c) removing the ultraviolet curable resin layer by using a paint remover; and (d) removing an ink layer of the fingerprint sensing module by using the paint remover.

### FIELD OF THE INVENTION

The present invention relates to the application field of surface treatment, and more particularly to a surface treatment method of surface cleaning of an electronic component.

### BACKGROUND OF THE INVENTION

With the enhancement of biology recognition technologies, many electronic products in life start to involve a biology recognition function. At present, a fingerprint recognition function has become one of standard configurations of an electronic apparatus, and a user may recognize an identity by using a fingerprint recognition module disposed on the electronic apparatus, so as to unlock or control the electronic apparatus.

Generally, the fingerprint recognition module has a fingerprint sensing unit and a protective layer covered on the fingerprint sensing unit. The fingerprint sensing unit includes: a sensing chip, a substrate electrically connected to the sensing chip, and an encapsulation layer covered on the substrate and the sensing chip. The protective layer includes: a primer layer, an ink layer, and a finish layer. The primer layer is coated on a surface of the fingerprint sensing unit, and is used to improve an adhesive capability between the ink layer and the fingerprint sensing unit, so that the ink layer can be combined with the fingerprint sensing unit more easily. The ink layer is a colored layer of a single layer or multiple layers, and is used to form tone or shine of the appearance of the fingerprint recognition module. The finish layer is configured on the ink layer, and is used as a protective layer for pressing of a user.

Because the finish layer needs to be in contact with fingers of a user and an external environment frequently, to avoid damage of the fingerprint recognition module, and improve physical strength of the fingerprint recognition module, the finish layer of the fingerprint recognition module usually has characteristics such as high hardness, high abrasion resistance, and good chemical resistance. Therefore, the finish layer is generally an ultraviolet curable resin material including elements such as an acrylic ester polymer and a photoinitiator, and is an ultraviolet curable resin layer formed after being cross-linked and solidified through radiation of ultraviolet light.

In a process of making a fingerprint recognition module, if a coating procedure of layers of the fingerprint recognition module goes wrong, a surface of the fingerprint recognition module may generate flaws such as particles, scratches, paint shedding, or stains. When the coating procedure goes wrong, a flawed protective layer needs to be removed, and then a procedure for remaking a protective layer for the fingerprint recognition module is performed. However, because the finish layer in the protective layer is mostly an ultraviolet curable resin layer made of an ultraviolet curable resin material, and has characteristics such as high hardness, high abrasion resistance, and good chemical resistance, the difficulty of removing the protective layer is also improved.

In the known technology, the flawed protective layer may be removed by using a surface treatment method such as solvent soaking, dry ice cleaning, or wheel grinding. However, when the solvent soaking method is used for treatment, a solvent first needs to be adjusted to an suitable pH value, and a time for soaking the fingerprint recognition module needs to be precisely controlled; when the dry ice cleaning method is used for treatment, an amount of dry ice and a cleaning pressure need to be concerned all the time; and when the wheel grinding method is used for treatment, a grinding surface may be uneven due to different grinding depths. In addition, excessive solvent soaking, dry ice cleaning, or wheel grinding may also cause encapsulation layer defects in the fingerprint sensing unit, and even cause exposure of a sensing chip, further affecting the procedure for remaking the protective layer of the fingerprint recognition module.

In view of this, how to provide a surface treatment method that may easily remove a protective layer of a fingerprint recognition module is a technical topic to be resolved in the present invention.

### SUMMARY OF THE INVENTION

A main objective of the present invention is to provide a surface treatment method that may easily remove a protective layer of a fingerprint sensing module.

To achieve the above objective, the present invention provides a surface treatment method, applicable to surface treatment of a fingerprint sensing module, where the method includes the following steps:

(a). providing a fingerprint sensing module;

(b). radiating at least one ultraviolet curable resin layer of the fingerprint sensing module by using a laser;

(c). removing the at least one ultraviolet curable resin layer by using a paint remover; and

(d). removing at least one ink layer of the fingerprint sensing module by using the paint remover.

In the above preferable implementation, in step (d), a primer layer of the fingerprint sensing module is further removed by using the paint remover.

In the above preferable implementation, in step (b), an output power of the laser is 5 W, and a pulse repetition rate is 35 kHz.

In the above preferable implementation, in step (b), a travel rate during the radiation of the laser is between 500 mm/sec and 900 mm/sec.

In the above preferable implementation, in step (c), the paint remover is benzyl alcohol, benzaldehyde, benzoic acid, or N-methylpyrrolidone.

### BRIEF DESCRIPTION OF THE DRAWINGS

FIG. 1A is a flowchart of a surface treatment method according to the present invention;

FIG. 1B is a detailed exploded flowchart of step S103 in FIG. 1A; and

FIG. 2 is a schematic diagram of a treatment procedure according to the present invention.

### DETAILED DESCRIPTION OF THE PREFERRED EMBODIMENT

Advantages and features of the present invention and a method for achieving them are more easily understood in more detailed description with reference to exemplary embodiments and the accompanying drawings. However, the present invention may be implemented in different forms and it should not be understood as only limited to the embodiments described herein. On the contrary, for a person of ordinary skilled in the art, the provided embodiments make this disclosure express the scope of the present invention more thoroughly, fully, and completely.

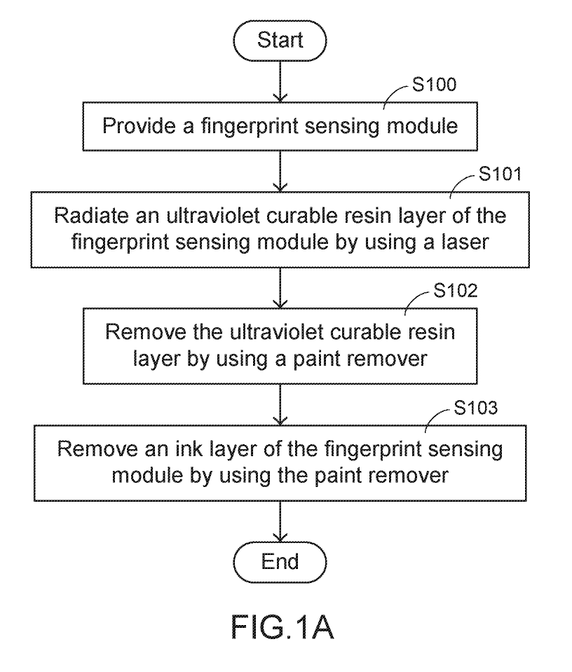

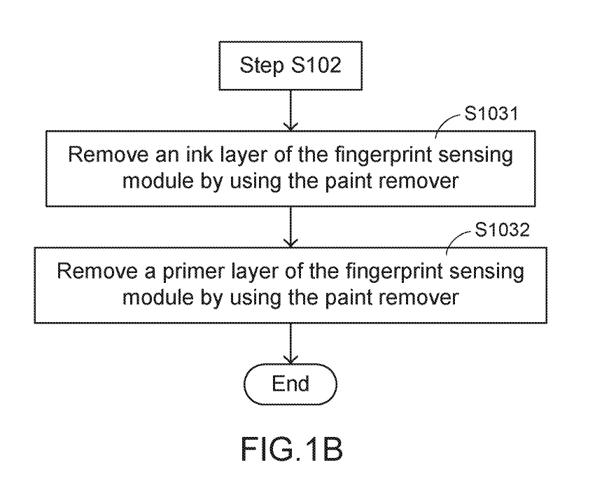

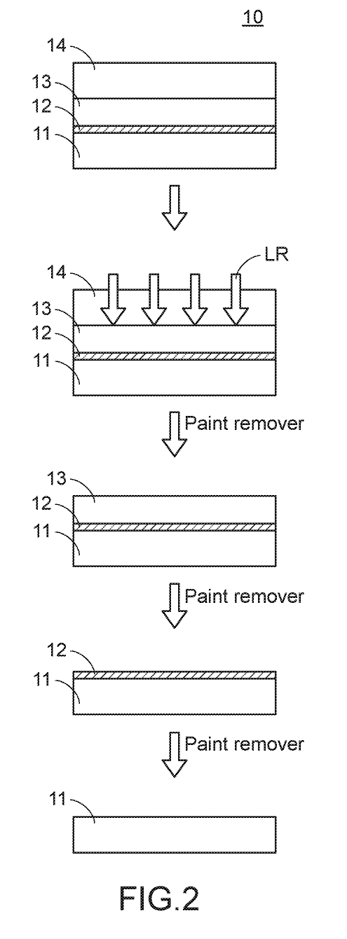

First, referring to FIG. 1A and FIG. 2, FIG. 1A is a flowchart of a surface treatment method according to the present invention. FIG. 2 is a schematic diagram of a treatment procedure according to the present invention. First, a fingerprint sensing module 10 is provided (step S100). In step S100, the fingerprint sensing module 10 includes: a fingerprint sensing unit 11 and a protective layer, where structures stacked on the protective layer from bottom to top includes: a primer layer 12, at least one ink layer 13, and an ultraviolet curable resin layer 14 (as shown in FIG. 2). The fingerprint sensing unit 10 is encapsulated by using a Land Grid Array (LGA) technology, and includes: a substrate (not shown in the figure), a sensing chip (not shown in the figure) electrically connected to the substrate, and an Epoxy Molding Compound (EMC) material (not shown in the figure) used for encapsulation. The primer layer 12 is coated on a surface of the fingerprint sensing unit 11, and is used to improve an adhesive capability between the ink layer 13 and the fingerprint sensing unit 11, so that the ink layer 13 may be combined with the fingerprint sensing unit 11 more easily. The ink layer 13 may be: a light curable ink layer, a heat curable ink layer, or a hybrid ink layer. The ultraviolet curable resin layer 14 is an ultraviolet curable resin material including an oligomer formed by a resin monomer and a prepolymer, and is formed after being cross-linked and solidified through radiation of ultraviolet light.

Next, an ultraviolet curable resin layer 14 of the fingerprint sensing module 10 is radiated by using a laser LR (step S101). In step S101, the ultraviolet curable resin layer 14 is radiated by using the laser LR, to break covalent bonding of an organic polymer in the material of the ultraviolet curable resin layer 14. In addition, the laser LR is not limited to a particular wavelength, and output powers of the laser LR, pulse repetition rates (PRRs), travel rates during radiation, and penetration depths during radiation on the ultraviolet curable resin layer 14 are shown in Table 1:

TABLE 1

| Output power | Pulse repetition rate | Travel rate | Penetration depth |
|---|---|---|---|
| (Unit: W) | (Unit: kHz) | (Unit: mm/sec) | (Unit: μm) |
| 5 W | 35 kHz | 500 mm/sec | 25 μm |
| 5 W | 35 kHz | 600 mm/sec | 23 μm |
| 5 W | 35 kHz | 700 mm/sec | 23 μm |
| 5 W | 35 kHz | 800 mm/sec | 21 μm |
| 5 W | 35 kHz | 900 mm/sec | 20 μm |

The radiation of the laser LR may break the covalent bonding of the organic polymer in the material of the ultraviolet curable resin layer 14, and make the material of the ultraviolet curable resin layer 14 lose original good chemical resistance. When a treatment procedure of radiation of the laser LR in step S101 is performed, the travel rate of the laser LR may be adjusted according to the thickness of the ultraviolet curable resin layer 14 of the fingerprint sensing module 10 to be treated, so as to change the penetration depth of the laser LR. In this way, that the over-effect of the laser LR breaks other structure layers can be avoided.

Next, the ultraviolet curable resin layer 14 is removed by using a paint remover (step S102). In step S102, a fiber rod or 3000 mesh abrasive paper may be used to adhere the paint remover, and then the fiber rod or abrasive paper adhered with the paint remover is used to scrub the ultraviolet curable resin layer 14. In this case, after the ultraviolet curable resin layer 14 is radiated by the laser LR, the material has lost the original good chemical resistance, and becomes easily decomposed. Therefore, the fiber rod or abrasive paper adhered with the paint remover may be used to remove the ultraviolet curable resin layer 14 easily. The paint remover may be: benzyl alcohol, benzaldehyde, benzoic acid, or N-methylpyrrolidone. Then, the ink layer 13 of the fingerprint sensing module 10 is removed by using the paint remover (step S103). In step S103, the fiber rod or 3000 mesh abrasive paper may be used to adhere the paint remover, and then the fiber rod or abrasive paper adhered with the paint remover is used to scrub the ink layer 13. The ink layer 13 is different from the ultraviolet curable resin layer 14, and does not have good chemical resistance. Therefore, the fiber rod or abrasive paper adhered with the paint remover may be used to remove the ink layer 13 easily.

Still referring to FIG. 1B and FIG. 2, FIG. 1B is a detailed exploded flowchart of step S103 in FIG. 1A. In FIG. 1B, after an ink layer 13 of the fingerprint sensing module 10 is removed by using the paint remover (step S1031), a primer layer 12 of the fingerprint sensing module 10 may be removed by using the paint remover (step S1032). In step S1032, the fiber rod or 3000 mesh abrasive paper may be used to adhere the paint remover, and then the fiber rod or abrasive paper adhered with the paint remover is used to scrub the primer layer 12. The primer layer 12 does not have good chemical resistance. Therefore, the fiber rod or abrasive paper adhered with the paint remover may be used to remove the primer layer 12 easily.

Compared with the known technology, the present invention provides a surface treatment method that may remove a protective layer of a fingerprint recognition module easily, and may maintain the integrity of a fingerprint sensing unit of a fingerprint sensing module. Therefore, the present invention actually is a creation with a high industrial value.

All sorts of modifications can be made to the present invention by a person skilled in the art, without departing from the protection scope of the appended claims.

What is claimed is:

1. A surface treatment method, applicable to surface treatment of a fingerprint sensing module, wherein the method comprises the following steps:
(a) providing the fingerprint sensing module;
(b) radiating at least one ultraviolet curable resin layer of the fingerprint sensing module by using a laser;
(c) removing the at least one ultraviolet curable resin layer by using a paint remover; and
(d) removing at least one ink layer of the fingerprint sensing module by using the paint remover.

2. The surface treatment method according to claim 1, wherein in step (d), a primer layer of the fingerprint sensing module is further removed by using the paint remover.

3. The surface treatment method according to claim 1, wherein in step (b), an output power of the laser is 5 W, and a pulse repetition rate is 35 kHz.

4. The surface treatment method according to claim 1, wherein in step (b), a travel rate during the radiation of the laser is between 500 mm/sec and 900 mm/sec.

5. The surface treatment method according to claim 1, wherein in step (c), the paint remover is: benzyl alcohol, benzaldehyde, benzoic acid, or N-methylpyrrolidone.
